(19) United States
(12) Patent Application Publication
(10) Pub. No.: US 2010/0017744 A1
(43) Pub. Date: Jan. 21, 2010

(54) IMAGE DISPLAY CONTROL METHOD, IMAGE SUPPLY DEVICE, AND IMAGE DISPLAY CONTROL PROGRAM PRODUCT

(75) Inventors: Yosuke Kikuchi, Fuchu-shi (JP); Yuichi Kitazawa, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/486,887

(22) Filed: Jun. 18, 2009

(30) Foreign Application Priority Data
Jul. 16, 2008 (JP) 2008-184885

(51) Int. Cl. G06F 3/048

(52) U.S. Cl. 715/781; 715/862

(57) ABSTRACT

In at least one embodiment of the disclosure, an image display control method includes forming N display areas (where N is an integer equal to or greater than 2) corresponding to N image display devices in a display section of an image supply device. The N display areas in the display section have a visually recognizable one-to-one correspondence with N display images displayed by the image display devices. At least one image displayed in the respective display areas is supplied to the corresponding image display devices.

### CROSS-REFERENCE

The present application claims priority from Japanese Patent Application No. 2008-184885 filed on Jul. 16, 2008, which is hereby incorporated by reference in its entirety.

### BACKGROUND

When giving a presentation, there are some cases in which only an image field of a specific window rather than the entire screen displayed on a display device needs to be displayed on an external monitor. There is known a technology of outputting to an external monitor only the data of the window selected with a mouse pointer among a plurality of windows displayed on a display device (see, e.g., Japanese Patent Publication No. 2000-339130).

However, among other problems, when a plurality of image display devices are connected to an image supply device, it is difficult to display the same image on the plurality of image display devices, or to divide one image into divisional images and display the divisional images respectively on the image display devices.

### SUMMARY

Various embodiments of the disclosure have been developed in response to the current state of the art, and in response to problems, needs, and demands that have not been fully or completely solved by currently available systems, devices and methods. For example, various embodiments may solve at least a part of the problem described above, thereby improving convenience of operations of an image supply device.

At least one embodiment is directed to an image display control method in an image supply device adapted to supply at least one image to N (N is an integer equal to or greater than 2) image display devices including: (a) forming N display areas corresponding to the N image display devices in a display section different from the image display devices, and disposing the N display areas in the display section so that a one-on-one correspondence between N display images displayed by the image display devices and the N display areas is visually recognized, and (b) supplying images displayed in the respective display areas to the corresponding image display devices.

According to this embodiment, since it becomes possible to visually recognize the image displayed by the image display device using the image displayed in the display area of the display section of the image supply device, it becomes possible to enhance the convenience of operations of the image supply device.

At least one embodiment is directed to the image display control method of the previously described embodiment, wherein in step (a), movement of arrangement positions of the N display areas by a user is allowed.

According to this embodiment, it becomes possible to change the arrangement of the display area in accordance with the arrangement of the image displayed by the respective image display devices in response to change in the arrangement of the image displayed by the respective image display devices.

At least one embodiment is directed to the image display control method of at least one of the previously described embodiments, wherein in step (a), a miniature desktop area obtained by miniaturizing a desktop screen is formed in the display section.

According to this embodiment, it is possible to operate the image supply device using the desktop screen.

At least one embodiment is directed to the image display control method of the previously described embodiment, wherein step (a) includes (a1) forming one or more windows in the miniature desktop area, and (a2) displaying, when a correspondence between one window and the display area is designated on the display section, an image displayed on a selected window in a selected display area.

According to this embodiment, it becomes possible to display the image, which is displayed on the window, on the display area, and to supply the image display device with the image.

At least one embodiment is directed to the image display control method of any of the previously described embodiments, wherein in step (a), in response to selection of one of the display areas, a function operable to a screen displayed on the selected one of the display areas is displayed.

According to this embodiment, since the function operable to the screen displayed on the display area is displayed, it is possible to enhance the operability of the image supply device.

At least one embodiment is directed to the image display control method of at least one of the previously described embodiments, wherein in step (a), a cursor for selecting the display area is displayed, and in response to movement of the cursor onto one of the display areas, a function operable to a screen displayed on the one of the display areas is displayed.

According to this embodiment, since the operable function is displayed in response only to movement of the cursor onto the display area without selecting the display area, it is possible to enhance the operability of the image supply device.

At least one embodiment is directed to the image display control method of at least one of the previously described embodiments, wherein the operable function includes at least one of a mirroring function for displaying a screen, which is identical to a screen displayed on the display area, also on another display area, a multi-screen function for splitting the screen displayed on the display area to display the split screens respectively on the display area and another display area, and an edit function for editing the screen displayed on the display area.

According to this embodiment, it becomes possible to enhance the operability of the image supply device with these functions.

At least one embodiment is directed to the image display control method of at least one of the previously described embodiments, wherein in execution of the edit function, an edit screen for editing the screen displayed on the display area is formed and displayed.

According to this embodiment, it becomes easier to edit the screen.

It should be noted that the embodiments can be realized in various forms such as an image supply device, an image display control program product, or a storage medium storing the image display control program in addition to or instead of the image display control method.

### BRIEF DESCRIPTION OF THE DRAWINGS

Non-limiting and non-exhaustive embodiments of the present disclosure will now be described with reference to the accompanying drawings, wherein like reference numbers reference like elements.

FIG. 1 is an explanatory diagram showing a schematic configuration of an image supply system including an image supply device according to at least one embodiment.

FIG. 2 is a functional block diagram schematically showing an internal configuration of the image supply device according to an embodiment.

FIG. 3 is an explanatory diagram showing an example of a configuration of an identification image management file F1.

FIG. 4 is a functional block diagram schematically showing an internal configuration of an image display device used in an embodiment.

FIG. 5 is an explanatory diagram showing an example of a configuration of an identification image management file F34.

FIG. 6 is a flowchart showing an operation of the image display device.

FIG. 7 is a flowchart showing an operation of the image supply device.

FIG. 8 is a flowchart showing an operation of the image supply device.

FIG. 9 is an explanatory diagram showing a screen displayed on an indication display 40 while acquiring display information I33.

FIG. 10 is an explanatory diagram showing a selection screen of the image display device 30.

FIG. 11 is an explanatory diagram showing an overall view of the image supply system when selecting the image display device.

FIG. 12 is an explanatory diagram showing a condition in which the image display device is selected.

FIG. 13 is an explanatory diagram showing an example of a correspondence relationship between the window storage areas A1 through A3 for storing display image data and display supplying storage areas SPJ1 through SPJ3.

FIG. 14 is an explanatory diagram showing an operation screen.

FIG. 15 is an explanatory diagram showing an image display system when the selection is completed.

FIG. 16 is an explanatory diagram showing an example of an operation of establishing correspondence between contents and the image display devices 30.

FIG. 17 is an explanatory diagram showing an example of an operation of establishing correspondence between contents and the image display devices 30.

FIG. 18 is an explanatory diagram showing the image display system displaying images on the image display devices.

FIG. 19 is an explanatory diagram showing the image display system displaying windows respectively on two image display devices 30 (PJ1, PJ3).

FIG. 20 is an explanatory diagram showing an operation screen according to an alternative embodiment.

FIG. 21 is an explanatory diagram showing a condition in which a mirror icon 591 is selected in the operation screen shown in FIG. 20.

FIG. 22 is an overall view of the image display system immediately after the drop screen 533 is dropped on a small screen 534.

FIG. 23 is an explanatory diagram showing a condition in which a multi-screen icon 592 is selected in the operation screen shown in FIG. 20.

FIG. 24 is an overall view of the image display system immediately after the drop screen 533 is dropped on a small screen 534.

FIG. 25 is an overall view of the image display system immediately after the drop screen 533 is dropped on a small screen 536 in the condition shown in FIG. 23.

FIG. 26 is an explanatory diagram showing an edit screen.

FIG. 27 is an explanatory diagram showing the edit screen having been switched.

FIG. 28 is an explanatory diagram showing an alternative embodiment.

FIG. 29 is an explanatory diagram showing another embodiment.

### DESCRIPTION OF EMBODIMENTS

In the following description, reference is made to the accompanying drawings which form a part hereof, and in which are shown, by way of illustration, specific embodiments in which the disclosure may be practiced. It is to be understood that other embodiments may be utilized and structural or logical changes may be made without departing from the scope of the present disclosure. Therefore, the following description is not to be taken in a limiting sense, and the scope of the present disclosure is defined by the appended claims and their equivalents.

Throughout the specification and claims, the following terms take at least the meanings explicitly associated herein, unless the context clearly dictates otherwise. The meanings identified below are not intended to limit the terms, but merely provide illustrative examples for use of the terms. The meaning of “a,” “an,” “one,” and “the” may include reference to both the singular and the plural. Reference in the specification to “one embodiment” or “an embodiment” means that a particular feature, structure, or characteristic described in connection with the embodiment may be included in at least one embodiment of the disclosure. The appearances of the phrases “in one embodiment” or “in an embodiment” in various places in the specification do not necessarily all refer to the same embodiment, but it may.

Several embodiments will sequentially be described under corresponding section headings below. Section headings are merely employed to improve readability, and they are not to be construed to restrict or narrow the present disclosure. For example, the order of description headings should not necessarily be construed so as to imply that these operations are necessarily order dependent or to imply the relative importance of an embodiment. Moreover, the scope of a disclosure under one section heading should not be construed to restrict or to limit the disclosure to that particular embodiment, rather the disclosure should indicate that a particular feature, structure, or characteristic described in connection with a section heading is included in at least one embodiment of the disclosure, but it may also be used in connection with other embodiments.

The method or procedure is described in terms of firmware, software, and/or hardware with reference to the flowchart. Describing a method by reference to a flowchart enables one skilled in the art to develop programs, including instructions to carry out the processes and methods on suitably configured computer systems and processing devices. In various embodiments, portions of the operations to be performed by the image display control method may constitute circuits, general purpose processors (e.g., micro-processors, micro-controllers, an ASIC, or digital signal processors), special purpose processors (e.g., application specific integrated circuits or ASICs), firmware (e.g., firmware that is used by a processor such as a micro-processor, a micro-controller, and/or a digital signal processor), state machines, hardware arrays, reconfigurable hardware, and/or software made up of executable instructions. The executable instructions may be embodied in firmware logic, reconfigurable logic, a hardware description language, a state machine, an application-specific integrated circuit (ASIC), or combinations thereof.

With respect to various embodiments using a software implementation (e.g., a hardware simulator), at least one of the processors of a suitably configured processing device executes the instructions from a storage and/or recording medium. The computer-executable instructions may be written in a computer programming language or executable code. If written in a programming language conforming to a recognized standard, such instructions may be executed on a variety of hardware platforms and may interface with a variety of operating systems. Although the various embodiments are not described with reference to any particular programming language, it may be appreciated that a variety of programming languages may be used to implement the teachings of the embodiments as described herein. Furthermore, it is common in the art to speak of software in one form or another (e.g., program, procedure, process, application, etc.) as taking an action or causing a result. Such expressions are merely a shorthand way of saying that execution of the software causes the processor to perform an action or to produce a result.

### First Embodiment

### Configuration of Image Supply System

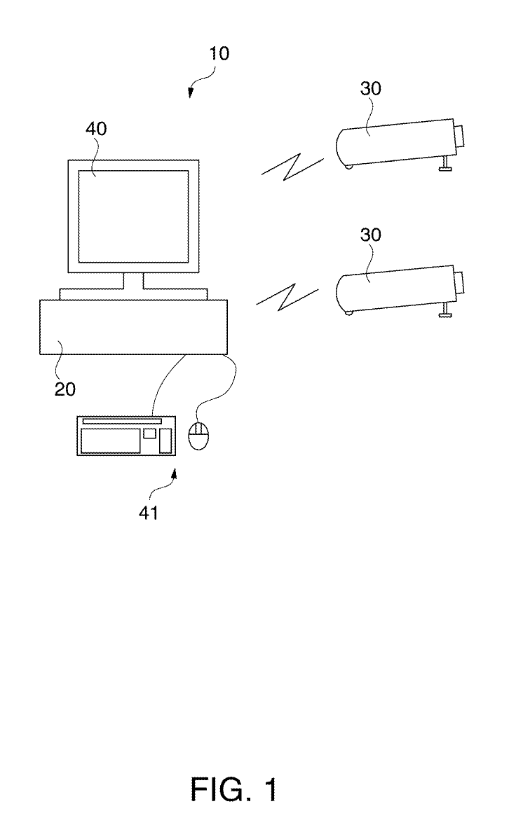

FIG. 1 is an explanatory diagram showing a schematic configuration of an image supply system including an image supply device according to a first embodiment. The image supply system 10 is provided with an image supply device 20 and image display devices 30. It should be noted that the image supply system 10 is referred to also as an image display system 10, and the image supply device 20 is referred to also as an image transfer device. A plurality of image display devices 30 is connected to the image supply device 20. The image supply device 20 and the image display devices 30 are connected to each other via, for example, a wireless local area network (LAN).

### Configuration of Image Supply Device

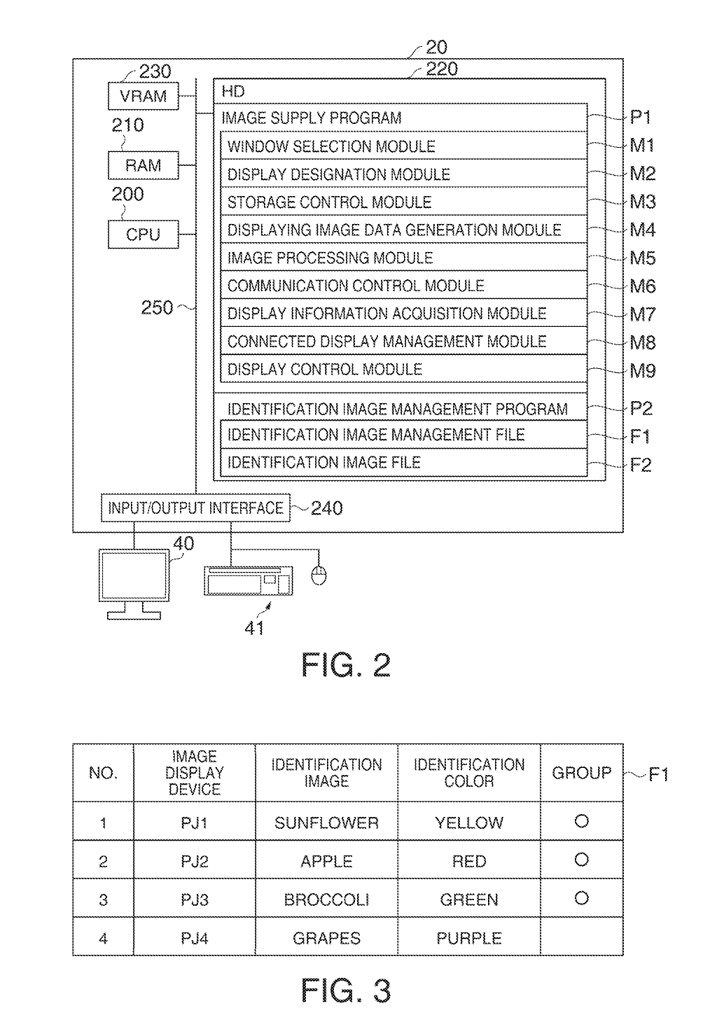

FIG. 2 is a functional block diagram schematically showing an internal configuration of the image supply device according to the first embodiment. The image supply device 20 is, for example, a personal computer, and is connected to an indication display 40, and input equipment 41 such as a keyboard or a mouse. The image supply device 20 is provided with a central processing unit (CPU) 200, a random access memory (RAM) 210, a hard disk drive (HDD) 220, a drawing memory (VRAM) 230, and an input/output interface 240. The CPU 200, the RAM 210, the HDD 220, the VRAM 230, and the input/output interface 240 are connected to each other via a common bus 250 so as to allow bi-directional communication.

The CPU 200, which is a logic circuit for executing various kinds of arithmetic processing, expands various programs and modules, which are stored in, for example, the HDD 220, in the RAM 210, and then executes them. The RAM 210 is a volatile memory, and stores temporarily the operation results of the CPU 200, and the displaying image data to be supplied to the image display devices 30. The VRAM 230 is a memory device for expanding and then temporarily buffering the displaying image data drawn based on the data, and is generally capable of reading and writing the data faster than the RAM 210.

The HDD 220 is a magnetic disk storage device for storing an image supply program P1 and an identification image management program P2. It should be noted that a nonvolatile semiconductor memory can also be provided instead of the HDD 220. The image supply program P1 stored in the HDD 220 is provided with a window selection module M1, a display designation module M2, a storage control module M3, a displaying image data generation module M4, an image processing module M5, a communication control module M6, a display information acquisition module M7, a connected display management module M8, and a display control module M9. The identification image management program P2 is provided with an identification image management file F1 and an identification image file F2. It should be noted that the functions of the modules are realized by the CPU 200 executing the respective modules.

The image supply program P1 is a program for supplying the image display device(s) with the image displayed on the indication display 40 connected to the image supply device 20. More specifically, the image supply program P1 in the present embodiment is capable of supplying each of image display device(s) with a plurality of contents displayed on the indication display 40 content by content. Here, the content denotes a display screen provided application by application, and includes each of word processing screens in word processing software, each of presentation screens in presentation software, a replay screen for reproducing the moving image content, which is delivered by the stream, and an edit screen and a display screen of a still image. Further, a so-called desk-top screen displayed as a background of the indication display 40 is also included in the content. It should be noted that each of these contents is called a window in the case of using Windows (a registered trademark) as an operating system, and therefore, is hereinafter referred to also as a “window.”

The window selection module M1 is a module executed for selecting a desired window among a plurality of windows displayed on the indication display 40. Specifically, the window selection module M1 specifies the window selected by the operator via the input equipment 41 among the plurality of windows. For example, by attaching unique numbers respectively to the windows (the windows opened on the screen) displayed on the indication display 40, it is possible to identify the windows, and specify the selected window. It should be noted that although it is possible that only one window is displayed on the indication display 40, in this case, the window selection module M1 specifies the window determined by the operator via the input equipment 41.

The display designation module M2 is a module for designating the image display device 30 to which the window selected by the window selection module M1 is output.

The storage control module M3 is a module for storing the selected window and the designated image display device 30 into the RAM 210 or the HDD 220 so as to be correlated with each other. The storage control module M3 also allocates window storage areas (content storage areas) for storing the displaying image data of the windows and display supplying storage areas for storing the image data transmitted to the image display devices 30 previously on the RAM 210 in accordance with the number of windows at least a part of which is displayed on the indication display 40, the number of image display devices 30 connected to the image supply devices 20, and the maximum resolution of the indication display 40. It should be noted that it is sufficient to allocate either one of the corresponding number of window storage areas to the number of windows and the corresponding number of display supplying storage areas to the number of image display devices 30 in the RAM 210 or the HDD 220.

The displaying image data generation module M4 is a module for generating the displaying image data of each of the windows displayed on the indication display 40. The displaying image data generation module M4 is capable of generating the displaying image data with respect to the windows existing on the indication display 40, in other words, all of the windows including the window hidden by another window and the window a part of which runs off the display screen of the indication display 40 and is not displayed thereon. This process is realized by, for example, drawing the displaying image data once on the VRAM 230 with respect not only to the window (the active window) in operation but to other windows when the window is selected, and then storing the displaying image data, thus drawn, at a predetermined location in the RAM 210. In this case, the display of other windows than the active window can be updated by executing the drawing process with respect to the other windows every time the other windows are selected. Alternatively, in the case in which the capacity of the VRAM 230 is large enough, it is possible to store the displaying image data of a plurality of windows on the VRAM 230.

The image processing module M5 is a module for executing various image processing on the displaying image data to be supplied to the image display devices 30. The image processing executed by the image processing module M5 includes processes such as a resolution conversion process, a sharpness control process, a brightness control process, or a color balancing process. Further, in the present embodiment, the image processing module M5 executes a process of modifying the displaying image data to be transmitted to the image display devices 30 in accordance with various operations, such as movement operation or modification operation (resizing operation), to a layout display window, which is displayed within a layout displaying area on the indication display 40. Specifically, the image processing module M5 moves the projection position of the image to be projected by the image display device 30 in response to the movement operation to the layout display window, and modifies the image to be projected by the image display device 30 in response to the modification operation to the layout display window.

The communication control module M6 is a module for controlling the input/output interface 240 for controlling transmission of connection information to, connection establishment with, and transmission of the displaying image data to the image display device 30, or performing reception of display information I33 from the image display device 30.

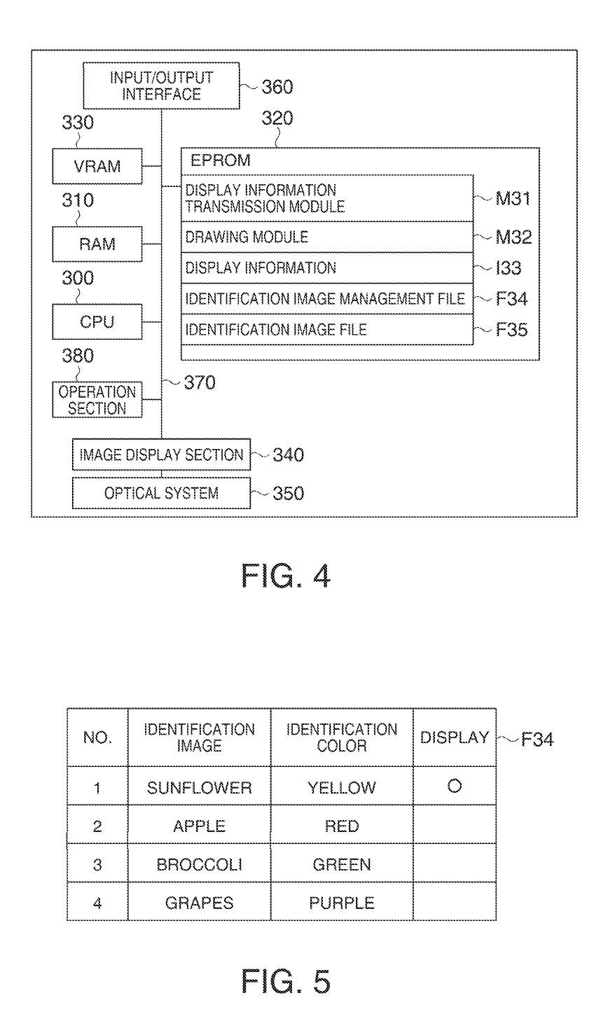

The display information acquisition module M7 is a module for acquiring the display information I33 (see FIG. 4) from the image display device 30. The display information I33 includes, for example, the maximum resolution supported by the image display device 30, a color profile (e.g., an ICC profile) of the image display device 30, identification information for specifying the image display device 30, and other information related to the image reproducing characteristic of the image display device 30.

The connected display management module M8 is a module for managing the number of image display devices 30 connected to the image supply device 20, namely connection and disconnection of the image display devices 30 to the image supply device 20.

The display control module M9 is a module for displaying an image on the indication display 40 using the displaying image data, and at the same time displaying the layout displaying area and the layout display window in a predetermined area on the indication display 40. The display control module M9 also modifies the display of the layout display window based on the operations, such as movement operation or modification operation (resizing operation), to the layout display window. The display control module M9 also modifies the size of the window displayed on the indication display 40 if the operation to the layout display window is the modification operation (resizing operation). Further, the display control module M9 displays a plurality of layout displaying areas with respect to the layout display window of the window running off the screen of the indication display 40, and displays the layout display window including the part thereof running off the screen of the indication display 40 through the plurality of layout displaying areas.

The identification image management program P2 manages the correspondence between the image display devices 30 and identification images using the identification image management file F1 and the identification image file F2. FIG. 3 is an explanatory diagram showing an example of a configuration of the identification image management file F1. The identification image management file F1 stores an identification image and correspondence with the identification color for each of the image display devices 30. The identification image file F2 stores the data of the identification images. Although in the present embodiment the identification image file F2 stores the image data of “a sunflower,” “an apple,” “broccoli,” and “grapes,” any images can be adopted providing the images can be distinguished from other images.

The input/output interface 240 shown in FIG. 2 is provided with a transmission/reception section for communicating signals between the image supply device 20 and external equipment such as the image display devices 30 in, for example, a wireless manner, and including switches for switching antennas and transmission/reception. Since the transmission/reception section is provided, an antenna access point (AP) function or a station (STA) function for transmitting/receiving the transmission signals and the reception signals is realized. The input/output interface 240 also receives an input signal from the input equipment 41 such as a keyboard or a mouse, and outputs the displaying image data to the indication display 40.

A “device determination/selection section: is realized using, for example, the display designation module M2, the storage control module M3, the display information acquisition module M7, the connected display management module M8, the display control module M9, and the identification image management program P2. When making correspondence between the windows and the image display devices 30, the window selection module M1 is also used as the device determination/selection section in addition thereto. The “image supply section” is realized using, for example, the displaying image data generation module M4, the image processing module M5, and the communication control module M6.

### Configuration of Image Display Device

FIG. 4 is a functional block diagram schematically showing an internal configuration of the image display device used in the first embodiment. The image display device 30 corresponds to, for example, a projector. As shown in FIG. 4, the image display device 30 is provided with a central processing unit (CPU) 300, a random access memory (RAM) 310, a nonvolatile memory (EPROM) 320, a drawing memory (VRAM) 330, an image display section 340, an optical system 350, an input/output interface 360, and an operation section 380. The CPU 300, the RAM 310, the EPROM 320, the VRAM 330, the image display section 340, the input/output interface 360, and the operation section 380 are connected to each other via a common bus 370 so as to allow bi-directional communication.

The CPU 300, which is a logic circuit for executing various kinds of arithmetic processing, expands various programs and modules, which are stored in, for example, the EPROM 320, in the RAM 310, and then executes them. The RAM 310 is a volatile memory device, and temporarily stores the result of calculation by the CPU 300. The VRAM 330 is a memory device for temporarily buffers the drawing data drawn based on the displaying image data.

The EPROM 320 is a semiconductor memory device for storing a display information transmission module M31, a drawing module M32, the display information I33, the identification image management file F34, and the identification image file F35. It should be noted that a magnetic disk storage device can also be used instead of the EPROM 320.

The display information transmission module M31 is a module for transmitting the stored display information to the image supply device 20. For example, when the connection between the image display device 30 and the image supply device 20 is established, the display information transmission module M31 acquires the stored display information I33, and then transmits the display information I33 to the image supply device 20 via the input/output interface 360.

The drawing module M32 analyzes the displaying image data received from the image supply device 20 via the input/output interface 360, and draws an image on the VRAM 330. Specifically, the drawing module M32 analyzes the displaying image data thus received to obtain the information such as the number of colors, sizes (vertical, lateral), coordinates, and image format, and then disposes pixel values in, for example, a bitmap manner on the VRAM 330 using the information thus obtained.

FIG. 5 is an explanatory diagram showing an example of a configuration of the identification image management file F34. The identification image management file F34 stores the identification images, a list of identification colors, and flags indicating which identification image is used as a default identification image. The identification image file F35 stores the data of the identification images. In the present embodiment the identification image file F35 stores the image data of “a sunflower,” “an apple,” “broccoli,” and “grapes,” and the image of “a sunflower” is set as the default image. It should be noted that although the default identification image is set to be different between the image display devices 30, if the default identification images overlap (i.e. are the same or similar) with each other, it is possible to change the default identification images by an operation in the operation section 380 or an instruction from the image supply device 20.

The image display section 340 is used for generating the image for projection using the drawing data stored in the VRAM 330. As the image display section 340, an image display section for modulating light beams from an RGB light source using liquid crystal panels, an image display section for modulating the light beams using digital micromirror devices (DMD) or reflective liquid crystal devices, for example, can be used without regard to the type thereof.

The optical system 350 is composed of a plurality of lenses, and is used for projecting the image generated in the image display section 340 on the projection surface with a predetermined size.

The operation section 380 is used when operating the image display device 30 manually, or when setting/modifying various settings. Here, the various settings include, for example, setting of the network, and the setting of which identification image is set as the default identification image.

### Operation of Image Display Device

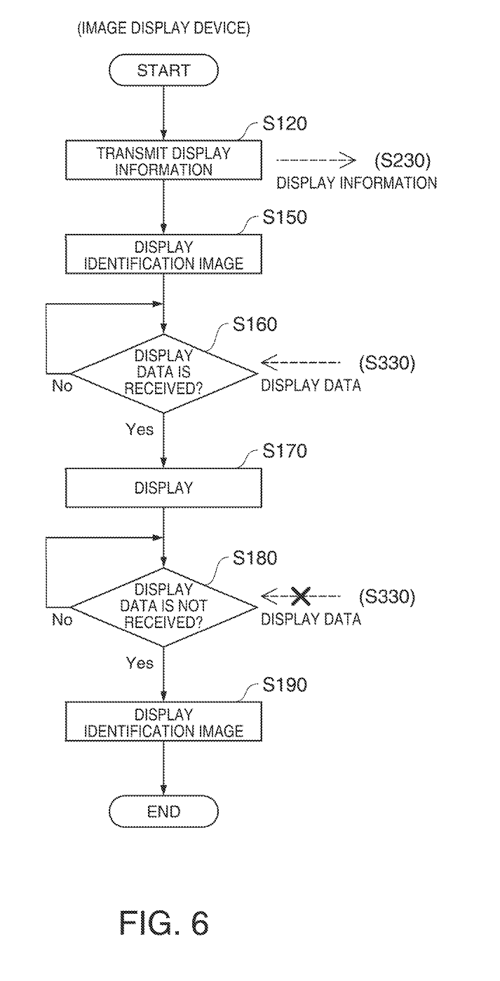

FIG. 6 is a flowchart showing an operation of the image display device. When the image supply program P1 of the image supply device 20 is started, the image supply device 20 transmits a request for the display information I33. In step S120, the CPU 300 transmits the display information I33 to the image supply device 20. Specifically, in each of the image display devices 30, the CPU 300 executes the display information transmission module M31 to obtain the display information I33 from the ROM 320, and then transmits it to the image supply device 20. It should be noted that the display information I33 also includes the information representing which identification image the image display device 30 uses as the default identification image.

In step S150, the CPU 300 projects the identification image on a screen 50 using the image display section 340 and the optical system 350. Thus, the user understands which identification image corresponds to which image display device 30.

When receiving the display data from the image supply device 20 in step S160, the CPU 300 projects the display data on the screen using the image display section 340 and the optical system 350 in step S170. Further, when the image supply device 20 stops transmitting the display data in step S180, the CPU 300 projects the identification image on the screen using the image display section 340 and the optical system 350 in step S190.

### Operation of Image Supply Device

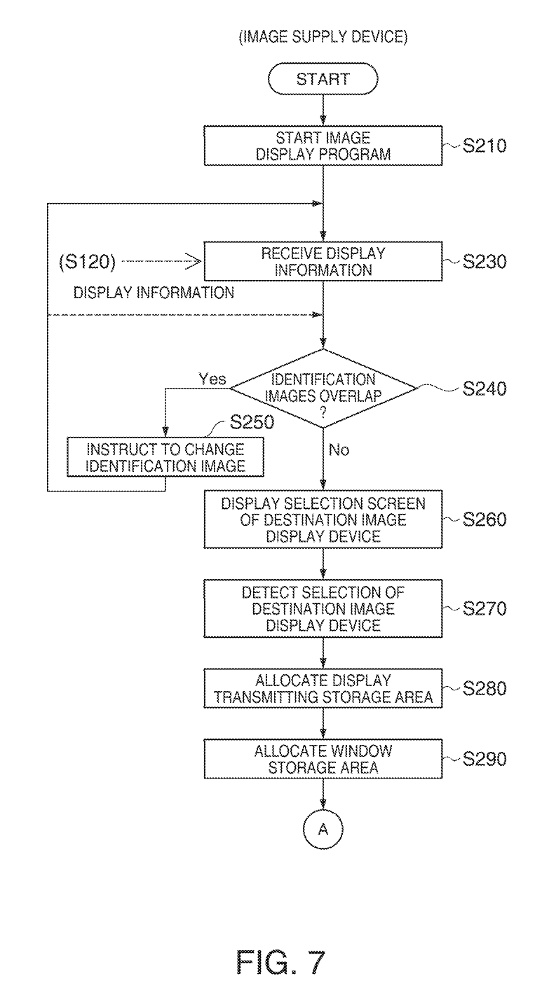

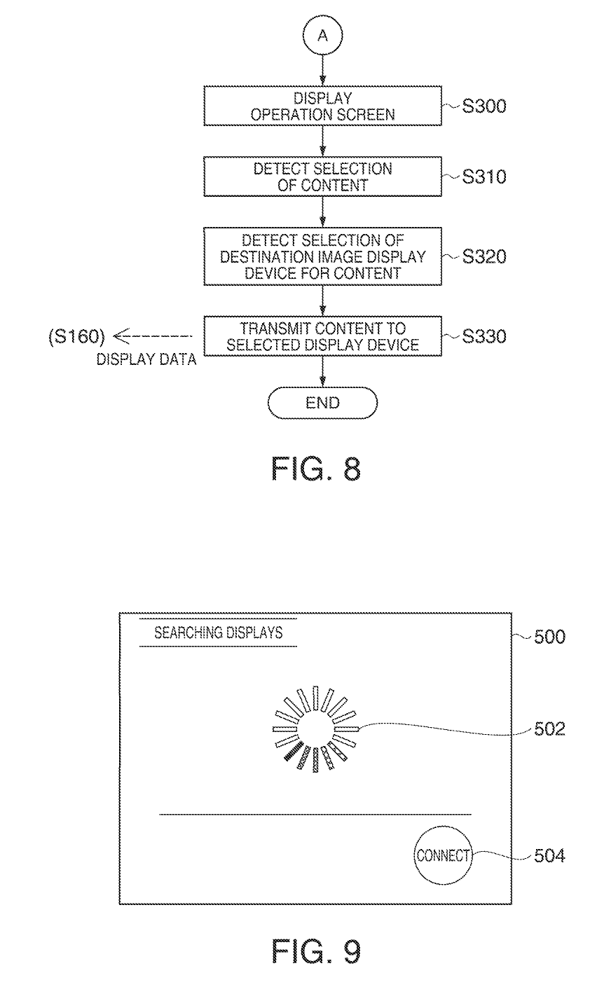

FIGS. 7 and 8 correspond to a flowchart representing an operation of the image supply device. When the image supply program P1 is started in step S210, the CPU 200 receives the display information I33 from the image display devices 30, and then stores the maximum supportable resolution, a color profile, identification information, and other image reproducing characteristics of each of the image display devices 30 in the HDD 220 with correspondence with the image display device 30 in step S230 using the display information I33 obtained from the image display devices 30. As described above, the display information I33 also includes the information representing which identification image the image display device 30 uses. In step S240, the CPU 200 determines whether or not the identification images transmitted from different image display devices 30 overlap (i.e. are the same or similar) with each other, and if the identification images overlap with each other, the CPU 200 executes display on the indication display 40 prompting to change the identification image in step S250.

FIG. 9 is an explanatory diagram showing a screen displayed on the indication display 40 while acquiring the display information I33. In the display information acquisition screen 500, there are displayed an indicator 502 and a connection button 504, and when receiving the display information I33 from the image display device 30, the CPU 200 displays a selection screen for the image display device 30 in step S260 of FIG. 7.

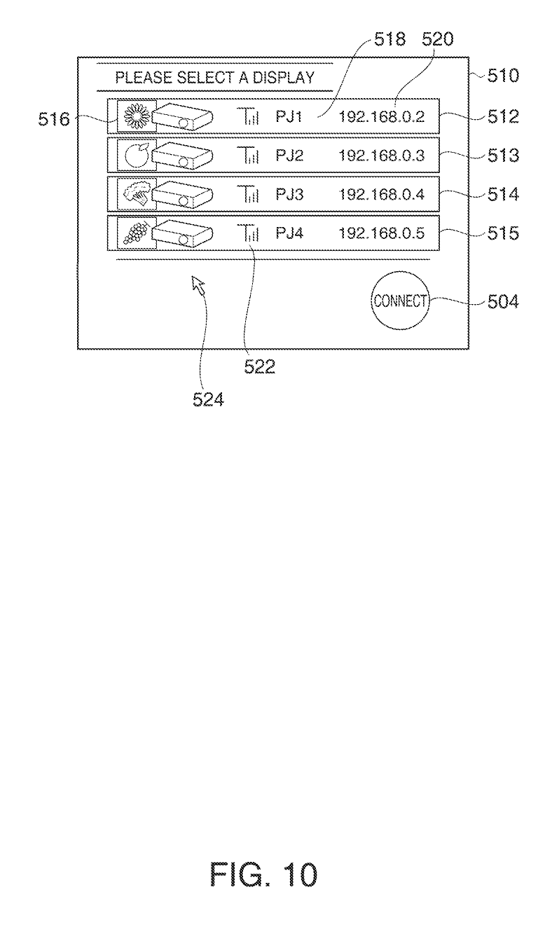

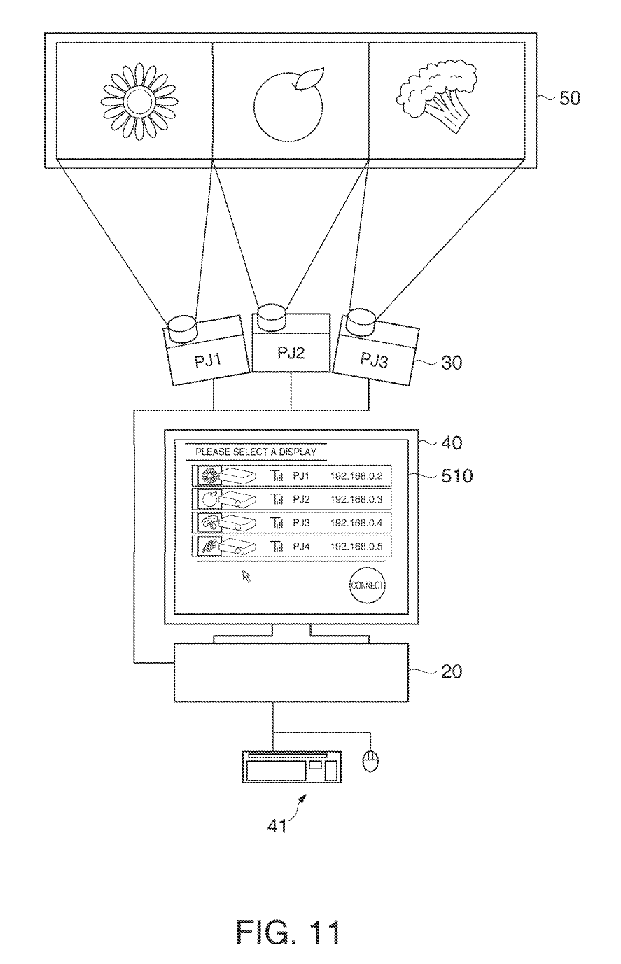

FIG. 10 is an explanatory diagram showing the selection screen for the image display device 30. On the selection screen 510, there are displayed selection columns 512 through 515 respectively representing all of the image display devices 30 which have received the display information I33, a mouse cursor 524, and a connection button 504. Each of the selection columns 512 through 515 is provided with an identification image display field 516, a device name display field 518, an IP address display field 520, and a radio field strength display field 522.

FIG. 11 is an explanatory diagram showing an overall view of the image supply system when selecting the image display device. The selection screen 510 shown in FIG. 10 is displayed on the indication display 40, and the projection images from the respective image display devices 30 are displayed on the screen 50. Here, on the selection screen 510, there are displayed four identification images corresponding respectively to the four image display devices 30, while the three identification images corresponding respectively to the image display devices 30, namely PJ1 through PJ3, are displayed on the screen 50. The reason therefore is that on the selection screen 510 the identification images of all of the image display devices 30 (PJ1 through PJ4) detected (from which the display information has been received) including the image display device 30 (PJ4) installed in a different meeting room. The identification image displayed in the identification image display field 516 is the same as the image projected from the corresponding image display device 30. Therefore, according to the present embodiment, since the user is allowed to select the image display devices 30 using the identification images displayed on the identification image display fields 516, it is more easy to determine or select the image display device 30, thus it becomes possible to enhance the convenience of operations of the image supply system 10. In step S270, the CPU 200 detects selection of the image display device 30.

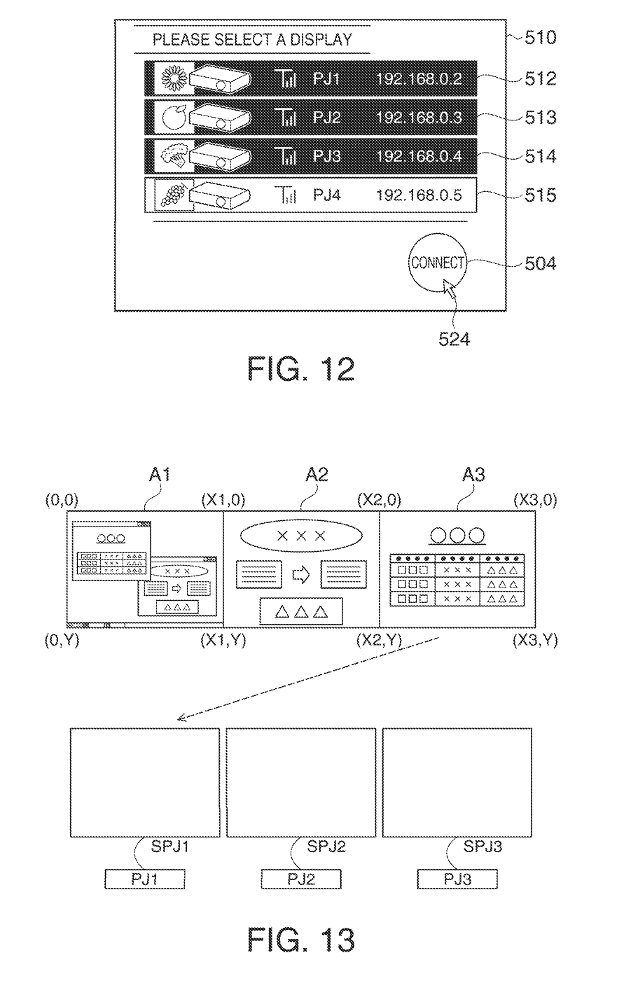

FIG. 12 is an explanatory diagram showing a condition in which the image display device is selected. In the drawing, the selection columns 512 through 514 out of the selection columns 512 through 515 are highlighted indicating that the three image display devices 30 corresponding to these selection columns 512 through 514 are selected. It should be noted that the CPU 200 can detect the selection of the image display device 30 by detecting a click on the selection columns 512 through 514 with the mouse cursor 524 located on the corresponding selection columns. When clicking the connection button 504 with the mouse cursor 524 located on the connection button 504, the connection with the selected image display device 30 is completed.

The CPU 200 executes the connected display management module M8 to specify the number of image display devices 30 connected to the input/output interface 240, and then executes the storage control module M3 to allocate the corresponding number of display supplying storage areas to the number of image display devices 30 connected thereto on the RAM 210 or the HDD 220 (step S280). The CPU 200 executes the storage control module M3 to allocate the corresponding number of window storage areas to the number of windows on the RAM 210 (step S290).

FIG. 13 is an explanatory diagram showing an example of a correspondence relationship between the window storage areas A1 through A3 for storing displaying image data and the display supplying storage areas SPJ1 through SPJ3. In the example shown in FIG. 13, the display supplying storage areas SPJ1 through SPJ3 are allocated (assigned) respectively to the image display devices 30 (PJ1 through PJ3). The number of image display devices 30 is specified by the CPU 200 detecting the number of wireless ports to which the image display devices 30 are connected, based on the detection of establish of the connection in the wireless communication, for example. It should be noted that it is not necessarily required that the display supplying storage areas SPJ1 through SPJ3 are contiguous with each other, and that the window storage areas A1 through A3 storing the displaying image data are contiguous with each other. Further, the capacities corresponding to the resolution of the primary display (the desktop screen) of the indication display 40 are assured in the display supplying storage areas SPJ1 through SPJ3.

For example, in Windows (a registered trademark), each of the windows is managed with a number called a handle, and the CPU 200 can obtain the handles of all of the windows displayed (opened) on the indication display 40 by executing the API function “EnumWindows.” Therefore, the CPU 200 allocates a plurality of window storage areas, which is necessary for storing all of the windows, in the RAM 210 in accordance with the number of handles thus obtained. It should be noted that as the capacity of each of the window storage areas, the capacity corresponding to the resolution of the desktop screen (the primary display) of the indication display is assured.

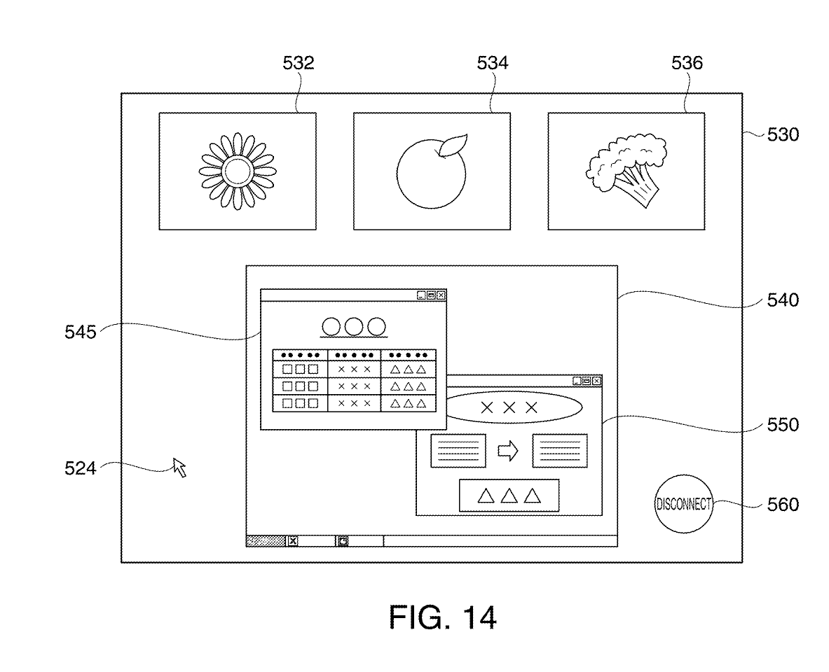

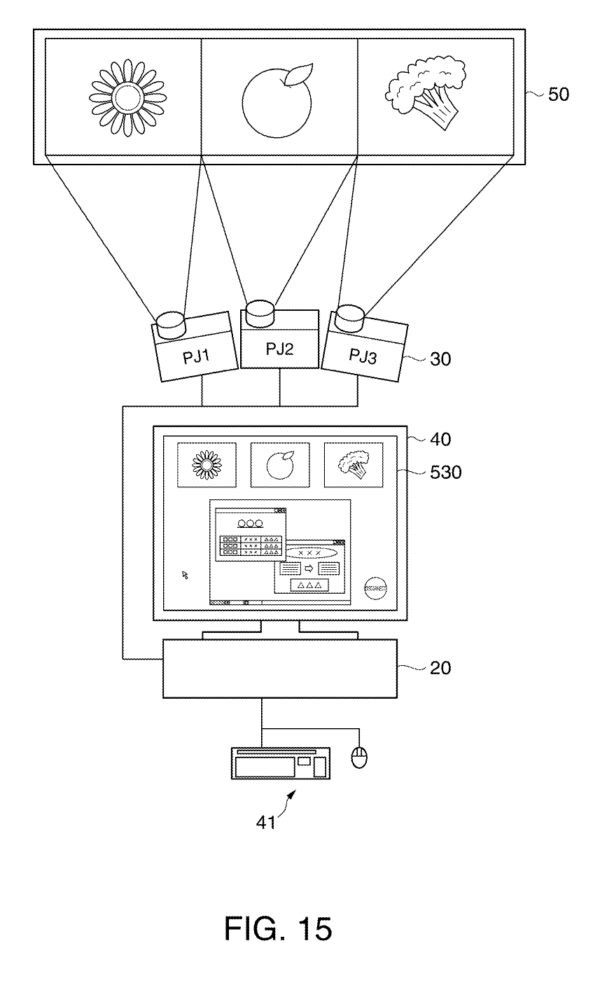

In step S300 shown in FIG. 8, the CPU 200 displays an operation screen 530. FIG. 14 is an explanatory diagram showing the operation screen. FIG. 15 is an explanatory diagram showing an image display system when the selection is completed. As shown in FIG. 14, on the operation screen 530, there are displayed small screens 532, 534, 536 and a desktop window 540. The number of small screens 532, 534, 536 corresponds to the number of selected image display devices 30. The images displayed of the small screens 532, 534, 536 are the same as the identification images projected by the image display devices 30 as shown in FIG. 15, and are displayed by, for example, writing the corresponding images from the identification image file F2 to the corresponding addresses to the small screens 532, 534, 536 of the VRAM 230. The desktop window 540 displays the entire desktop screen prior to start-up of the image supply program P1 in reduced size.

The CPU 200 executes the displaying image data generation module M4 to generate (capture) the displaying image data with respect to all of the windows displayed on the indication display 40. In the example shown in FIG. 14, two windows 545, 550 are displayed in the desktop window 540. These two windows 545, 550 can be said contents provided by application programs. It should be noted that in the case in which a part of the window runs off the desktop window 540, the displaying image data of the entire window including the part running off the desktop window 540 is generated although the part running off is not displayed on the desktop window 540. Further, the part running off includes a part running off the desktop window 540 in the case in which the window is located with an offset from the desktop window 540, and a part running off the desktop window 540 in the case in which the entire window is not fitted in the desktop window 540. Although the displaying image data thus generated can be stored in a single window storage area in the former case, in the latter case, the displaying image data thus generated is stored in a plurality of window storage areas so as to straddle the window storage areas.

For example, in the case in which Windows (a registered trademark) is adopted as the operating system, by adopting a layered window, the displaying image data corresponding to all of the windows displayed on the indication display 40 is generated. The CPU 200 sequentially executes “GetWindowLong” as an API function for acquiring the setting values of the present window, an API function “SetWindowLong” for registering the present window style acquired in “GetWindowLong” after making OR with the layered setting API “WS_EX_LAYERED,” and an API function “SetLayeredWindowAttributes” for setting the layered parameters of the designated window, thereby making each of the windows a layered window. With respect to each of the windows made to be the layered window, the entire window is captured, in other words, the displaying image data corresponding to the entire window is generated.

The displaying image data generation module M4 develops (draws) the displaying image data based on the application programs corresponding respectively to the windows, thereby generating the displaying image data. The displaying image data thus generated is sequentially stored in the window storage area previously allocated on the RAM 210. In the example shown in FIG. 13, the displaying image data of the desktop window 540 is stored in the first window storage area A1, and the displaying image data of the windows 550, 545 are stored respectively in the second and third window storage areas A2, A3. In the present embodiment, the storage control module M3 manages the window storage areas A1 through A3 using the coordinates (X, Y), and for example, the location of the window (displaying image data) on the display screen of the indication display 40 is managed using the upper left coordinate point as the origin. Further, the projection position of the image with respect to the projection frame when projected actually corresponds to the storing position of the displaying image data stored in the respective window storage areas, and the position of the image thus projected can be specified by specifying the coordinate in the respective window storage areas. Further, it is also possible to specify the pixel data constituting the displaying image data using the coordinates applied to the window storage areas.

Returning to FIG. 8, in step S310, the CPU 200 detects selection of the content, and in step S320, the CPU 200 executes the display designation module M2 to detect selection of the image display device 30 to which the content is supplied.

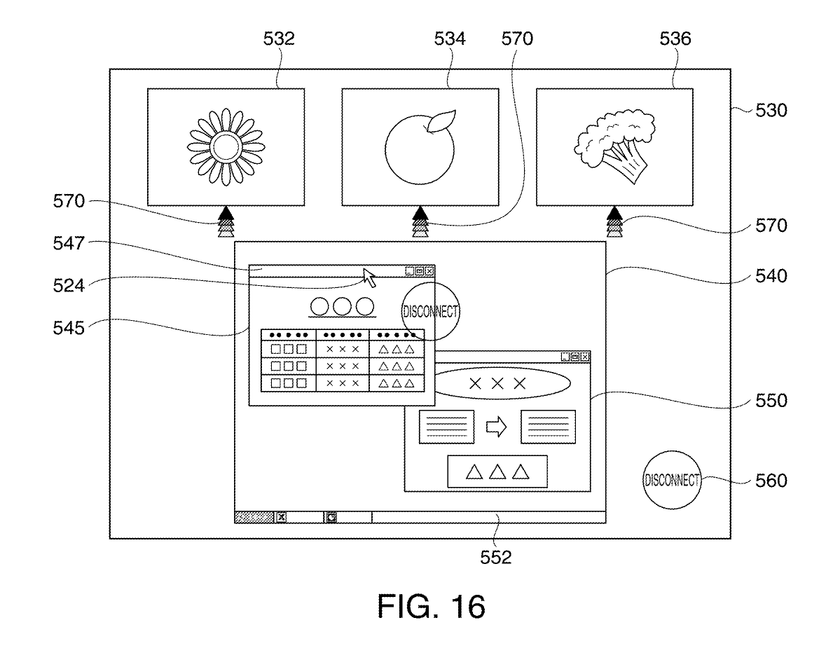

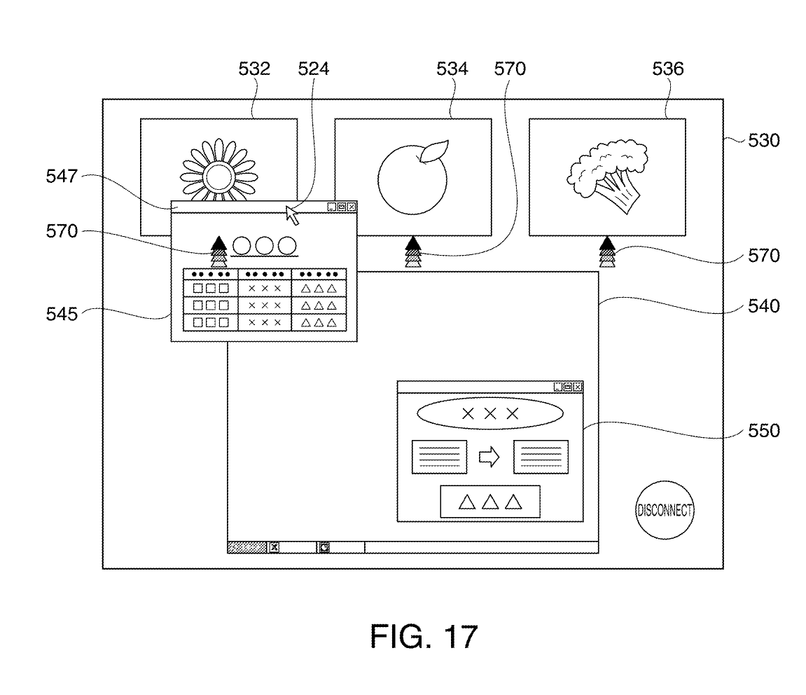

FIGS. 16 and 17 are explanatory diagrams showing an example of an operation of establishing correspondence between contents and the image display devices 30. When clicking the title bar 547 of the window 545 with the mouse cursor 524 located on the title bar, the window 545 is selected, and as shown in FIG. 16, arrows 570 to the small screens 532 through 536 corresponding to the image display devices 30 which can be displayed are displayed. As shown in FIG. 17, when dragging the mouse cursor 524 and then dropping the window 545 on the small screen as the destination of the arrow 570, the small screen 532, for example, the CPU 200 executes the storage control module M3 to make correspondence between the window 545 and the image display device 30 corresponding to the small screen 532. Specifically, the CPU 200 executes the storage control module M3 to make correspondence between the window storage area for storing the displaying image data corresponding to the selected window and the display supplying storage area corresponding to the designated image display device.

In step S330 of FIG. 8, the CPU 200 transmits the content of the selected window 545 to the selected image display device 30. Specifically, the CPU 200 executes the storage control module M3 to copy or move the displaying image data of the window 545 stored in the window storage area to the display supplying storage area as a supplying storage area to the image display device 30 (PJ1). It should be noted that the correspondence between the image display devices 30 (PJ1 through PJ3) and the respective storage areas can be realized by, for example, making a correspondence between the port numbers to which the image display devices 30 (PJ1 through PJ3) are respectively connected, or MAC addresses of the communication control modules of the respective image display devices 30 (PJ1 through PJ3) and the coordinate information for defining the respective storage areas.

When the correspondence between the selected window and the designated image display device has been established, the CPU 200 executes the image processing module M5 to execute necessary image processing on the displaying image data. In the present embodiment, the image processing to the displaying image data is executed on the respective display supplying storage areas SPJ1 through SPJ3. As the image processing, there are executed using the display information I33, for example, a resolution conversion process, an image quality control process such as a sharpness control process, a brightness control process, or a color balance control process, and a composition process of the displaying image data. In the case in which it is required to project a plurality of windows on one image display device 30 using the composition process, it is possible to supply the image display device 30 with the displaying image data along the image displayed on the indication display 40.

The CPU 200 further executes the communication control module M6 to supply the corresponding image display devices 30 (PJ1 through PJ3) with the displaying image data, on which the image processing has been executed and which is stored in the respective display supplying storage areas SPJ1 through SPJ3. It should be noted that after the correspondence between the window and the image display device 30 has been made, generation of the displaying image data of the window on the indication display 40 and transmission of the displaying image data to the respective image display devices 30 (PJ1 through PJ3) are repeatedly executed at predetermined timing. Alternatively, in the case in which the content does not vary with time, it is possible to execute generation of the displaying image data of the corresponding window and transmission of the displaying image data to the respective image display devices 30 (PJ1 through PJ3) at the timing when the window becomes active. Thus, it is possible to project the image corresponding to the latest window at any time after the correspondence between the window and the image display device 30 has once been established.

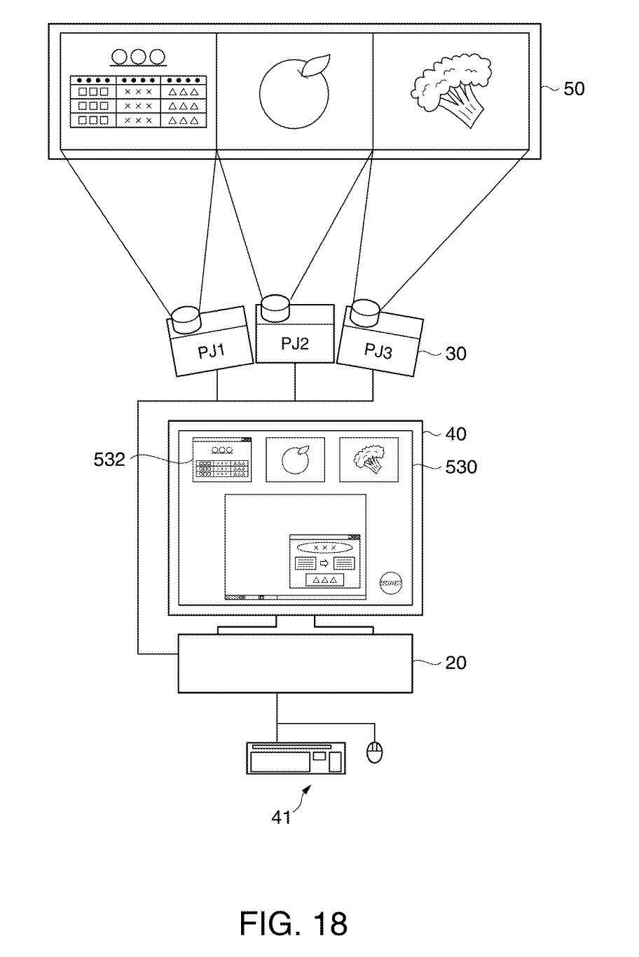

FIG. 18 is an explanatory diagram showing the image display system displaying images on the image display devices. The content (FIG. 14) having been displayed on the window 545 is displayed on the small screen 532 and the projection screen of the image display device 30 (PJ1). It should be noted that the identification image is displayed on the small screens 534, 536 and the projection screens of the image display devices 30 (PJ2, PJ3).

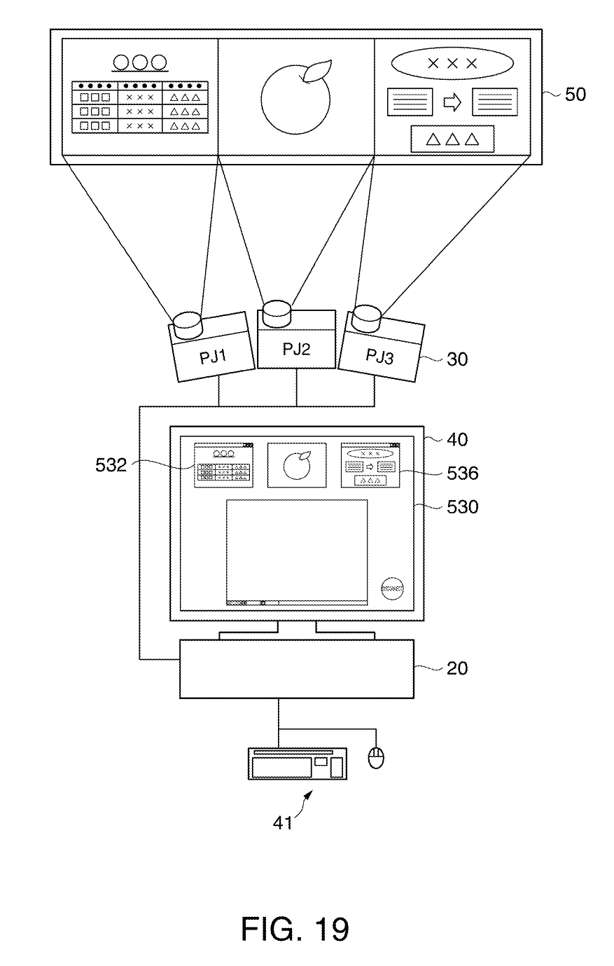

FIG. 19 is an explanatory diagram showing the image display system displaying windows respectively on two image display devices 30 (PJ1, PJ3). The content (FIG. 14) having been displayed on the window 545 is displayed on the small screen 532 and the projection screen of the image display device 30 (PJ1), and the content having been displayed on the window 550 is displayed on the small screen 536 and the projection screen of the image display device 30 (PJ3). As described above, it is also possible to supply a plurality of image display device 30 with images of a plurality of windows.

As described above, according to the present embodiment, since it is possible to perform selection of the image display device 30 using the identification images, it becomes possible to make the determination or the selection of the image display device 30 easier, thereby enhancing convenience of operation of the image supply system 10. It should be noted that although in certain embodiments the identification image displayed by the image display device 30 is the same as the identification image displayed on the indication display 40 of the image supply device 20, it is possible to make the identification images different from each other providing the identification images correspond to each other.

Further, selection of the image display device to which an image is to be supplied and displayed may be performed by selecting the image display device from a list of possible destination image display devices, such as from a selection screen that includes a list of possible destination image display devices detected (see, e.g., FIGS. 10 through 12), and/or selecting an image supply device to which an image is supplied from among previously selected destination image display device(s) (see, e.g., FIGS. 14 through 17).

In the present embodiment, since the image supply device 20 causes the image display 30 to change the corresponding identification image in the event the identification images corresponding to the image display devices 30 overlap (i.e. the identification images are the same or similar) with each other, the overlap of identification images may be prevented.

Further, in the present embodiment since the small screens 532, 534, 536 are arranged so that the one-to-one correspondence between the display images displayed by the image display devices 30 and the small screens 532, 534, 536 can visually be recognized, it is possible to assume appearance of the display image of the image display device from the appearance of the small screens 532, 534, 536, thus it becomes possible to enhance the convenience of operation of the image supply device 20.

Further, in the present embodiment, since the CPU 200 displays the desktop window 540, it becomes more easy to select the image to be supplied to the image display device using the window in the desktop window 540. As a result, it becomes possible to enhance the convenience of operations of the image supply device 20.

Although in the present embodiment the small screens 532, 534, 536 are arranged so that the one-to-one correspondence between the display images displayed by the image display devices 30 and the small screens 532, 534, 536 can visually be recognized, it is also possible to adopt the configuration in which when the position of the display image displayed by the image display device 30 varies, the position and the size can be changed in response to an operation such as a drag operation by the user.

### Second Embodiment

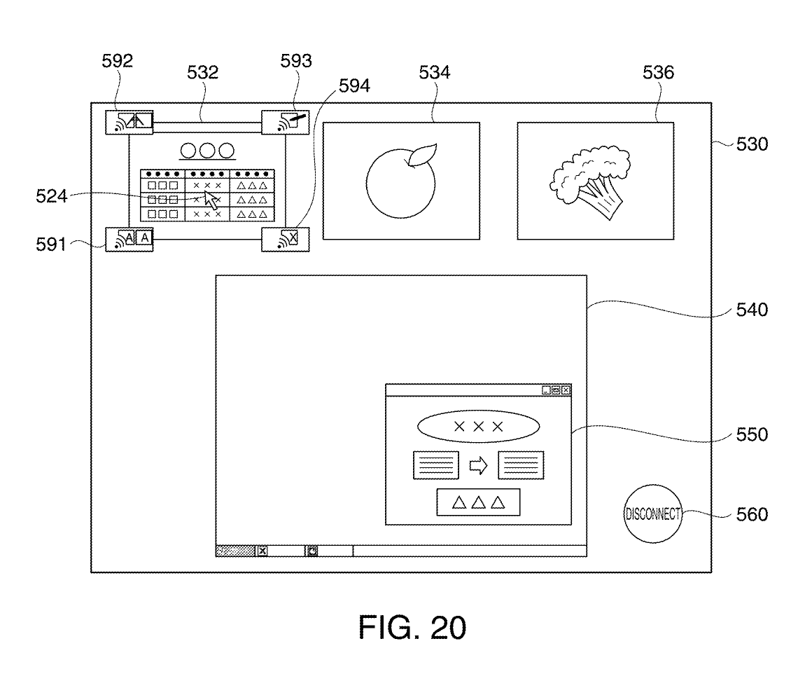

FIG. 20 is an explanatory diagram showing an operation screen according to a second embodiment. On the four corners of the small screen 532 of the operation screen 530, there are displayed four functional icons 591 through 594. These functional icons 591 through 594 are used for realizing a mirroring function, a multi-screen function, an edit function, and a function of stopping transmission of an image to the image display device 30, respectively. Hereinafter, the functional icons 591 through 594 are referred to also as a “mirror icon 591,” a “multi-screen icon 592,” an “edit icon 593,” and a “transmission abort icon 594,” respectively. Here, the mirroring function denotes the function of displaying the same window on two or more image display devices 30, and the multi-screen function denotes the function of dividing one window into two or more parts and displaying them by respective displays. These functional icons 591 through 594 are displayed on the four corners of the small screen 532 when the small screen 532 is selected by the mouse cursor 524. Here, the CPU 200 detects the selection of the small screen 532 by a click on the small screen 532 with the mouse cursor 524 located on the mirror icon 591. It should be noted that it can also be arranged that the functional icons 591 through 594 are displayed when it is detected that the mouse cursor 524 simply moves into the small screen 532 regardless of the click with the mouse cursor 524 located on the mirror icon 591.

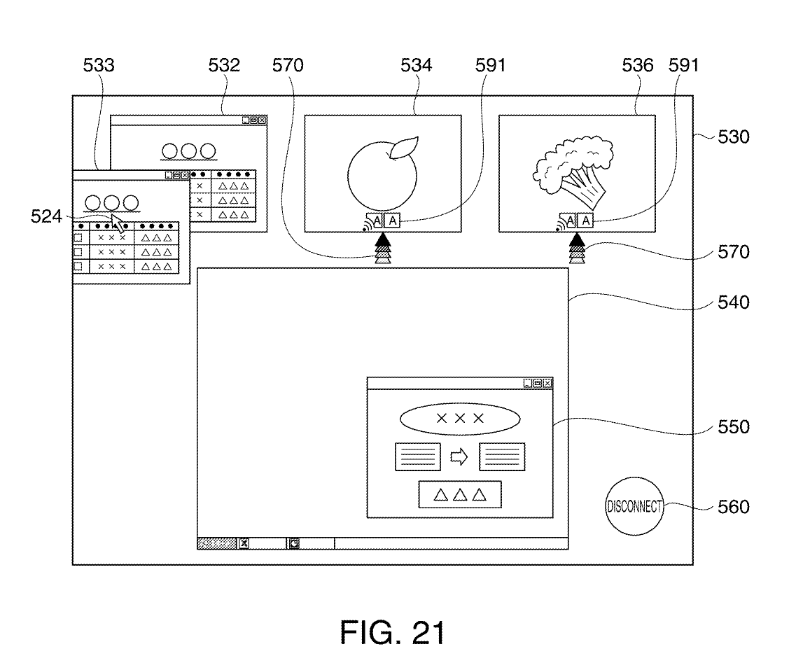

FIG. 21 is an explanatory diagram showing a condition in which the mirror icon 591 is selected in the operation screen shown in FIG. 20. For example, the mirror icon 591 is selected by clicking the mirror icon 591 with the mouse cursor 524 located on the mirror icon 591. When the mirror icon 591 is selected, a drop screen 533 and the arrows 570 are displayed on the operation screen 530. Further, on this occasion, the mirror icons 591 are displayed on the small screens (the small screens 534, 536 in the present embodiment), which can be selected as a dropping destination. The drop screen 533 is the same screen as the small screen 532, but is paled out in comparison with the small screen 532, for example, in order for notifying the user of the drop screen 533. The arrows 570 and the mirror icons 591 are used for indicating the small screens, which can be selected as the dropping destination of the drop screen 533, and the function realized by dropping. In this screen, they indicate that the drop screen 533 can be dropped on the small screens 534, 536, and that the mirror screen is displayed by dropping.

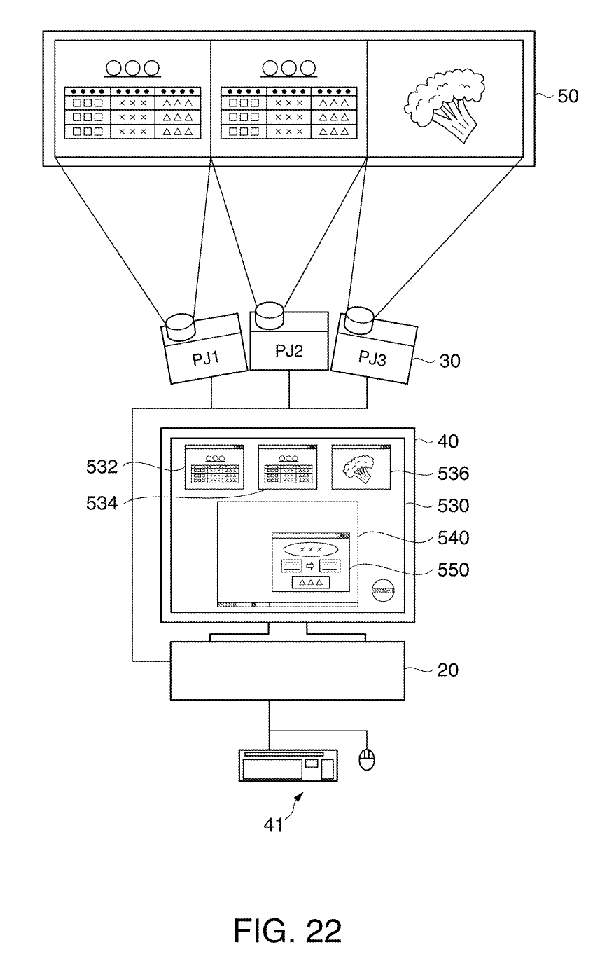

FIG. 22 is an overall view of the image display system immediately after the drop screen 533 is dropped on the small screen 534. The same window 545 (FIG. 14) is displayed on the small screens 532, 534, and the content of the window 545 is displayed on the image display devices 30 of PJ1 and PJ2. The one-to-one correspondence between the display images displayed by the image display devices 30 and the small screens 532, 534, 536 is visually recognized.

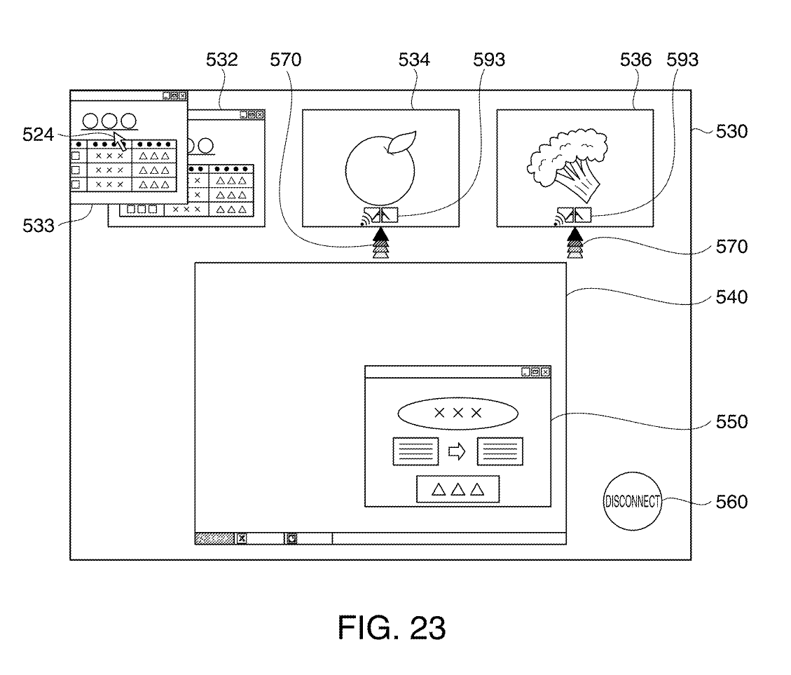

FIG. 23 is an explanatory diagram showing a condition in which the multi-screen icon 592 is selected in the operation screen shown in FIG. 20. Here, the multi-screen icon 593 is displayed on the small screens 534, 536 instead of the mirror icon 591.

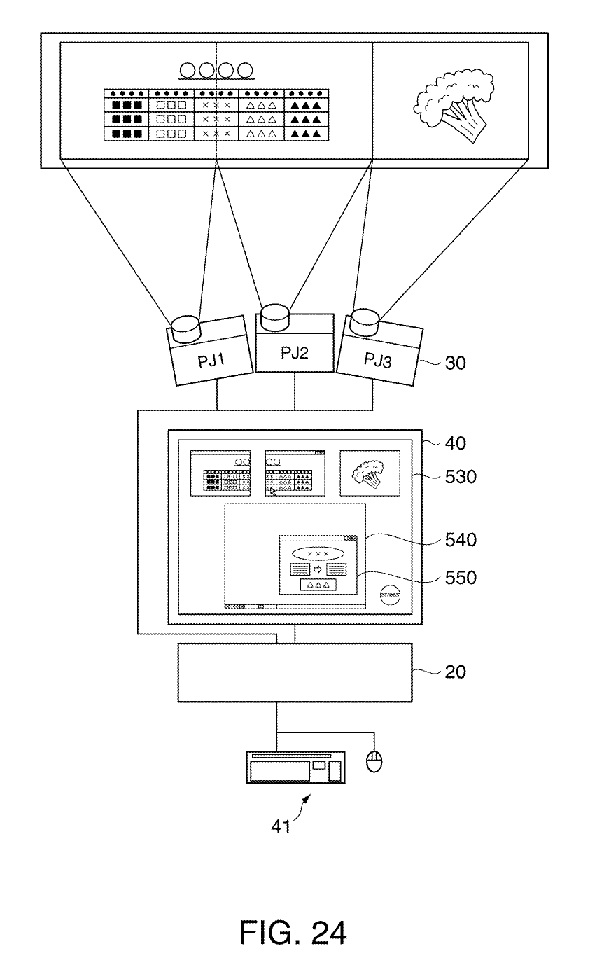

FIG. 24 is an overall view of the image display system immediately after the drop screen 533 is dropped on the small screen 534. The window 545 is split into right and left halves, and the left half of the window 545 (FIG. 14) is displayed on the small screen 532 while the right half thereof is displayed on the small screen 534. Further, the left half of the window 545 is displayed on the PJ1 and the right half thereof is displayed on the PJ2. Also on this occasion, the one-to-one correspondence between the display images displayed by the image display devices 30 and the small screens 532, 534, 536 is visually recognized. It should be noted that depending on the size of the window 545, the images displayed on the small screen 534 and the image display device 30 (PJ2) can correspond to the part of the window 545 hidden on the right thereof.

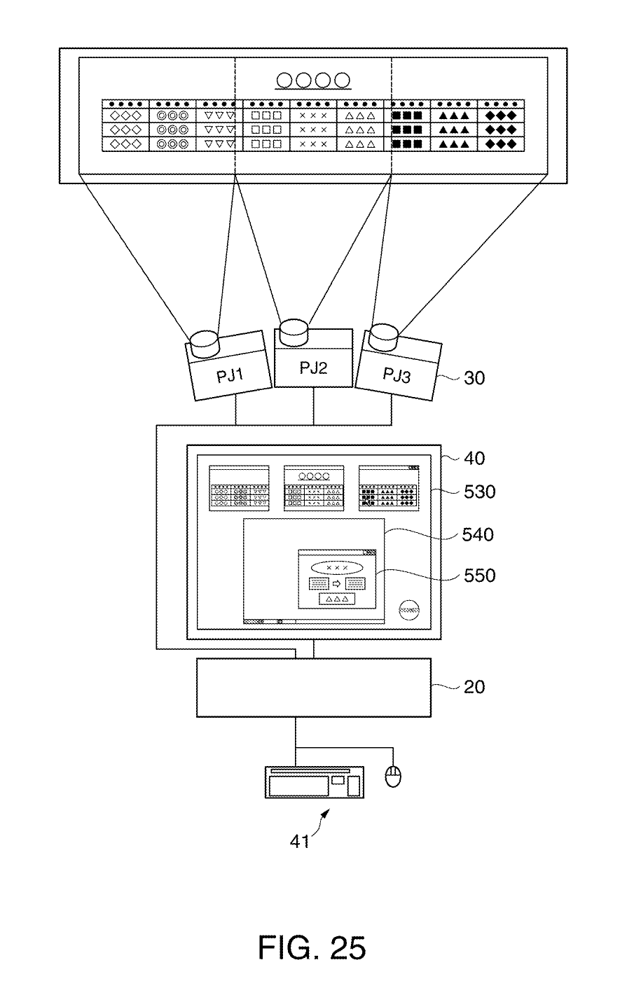

FIG. 25 is an overall view of the image display system immediately after the drop screen 533 is dropped on a small screen 536 in the condition shown in FIG. 23. On this occasion, the screen of the window 545 is split into three sections, and the three sections are displayed on the small screens 532, 534, 536, and the PJ1 through PJ3, respectively.

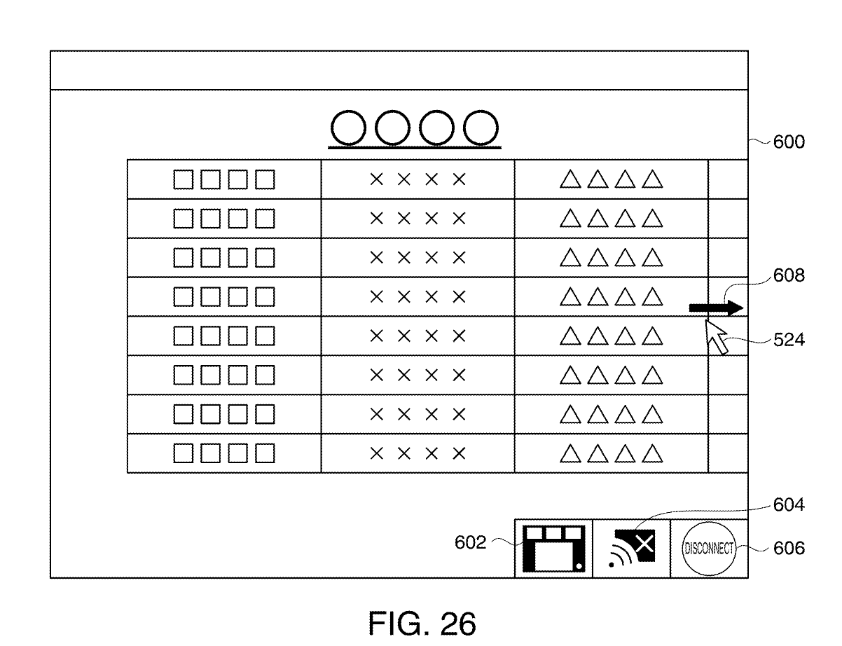

FIG. 26 is an explanatory diagram showing the edit screen. For example, in FIG. 20, when the edit icon 593 is selected, an edit screen 600 obtained by expanding the content of the small screen 532 to the overall size of the indication display 40 is displayed. On the edit screen 600, there are displayed a return icon 602, the transmission abort icon 604, and a program abort icon 606. The return icon 602 is used for returning the edit screen 600 to the operation screen 530. The transmission abort icon 604 is used for aborting the transmission of the image to the image display device 30. The program abort icon 606 is used for aborting the execution of the image supply program P1. Further, when detecting the mouse cursor 524 moved to the end (the right end in the present embodiment) of the screen, the CPU 200 displays an arrow 608. When detecting the click on the arrow 608 with the mouse cursor 524 in this condition, the CPU 200 switches the screen to be displayed on the edit screen 600 to the content of the small screen 536.

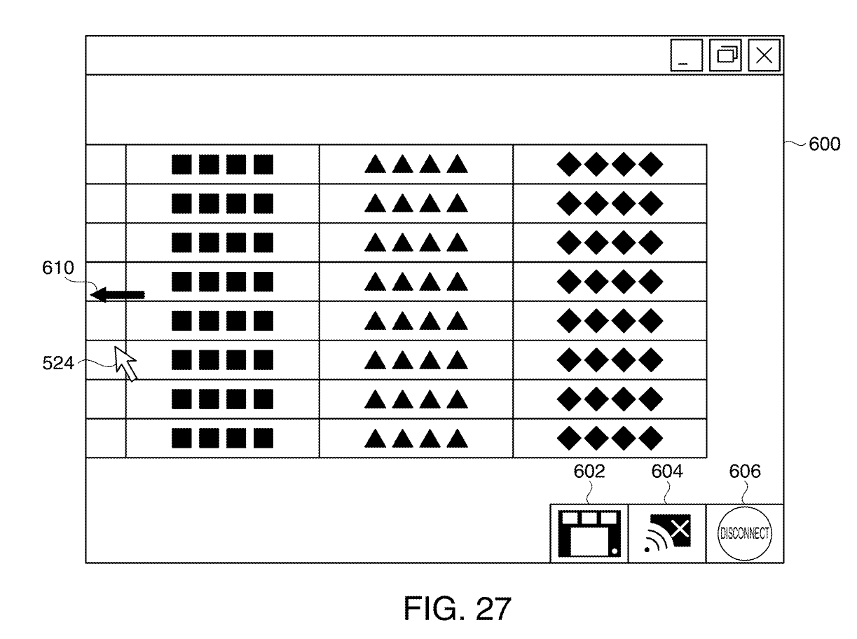

FIG. 27 is an explanatory diagram showing the edit screen having been switched. When detecting the mouse cursor 524 moved to the end (the left end in the present embodiment) of the screen, the CPU 200 displays an arrow 610 for returning to the edit of the small screen 534. It should be noted that it is also possible to arrange that a scrollbar slider is displayed instead of the arrows 608, 610, and the content displayed on the edit screen 600 is moved by moving the scrollbar slider.

In the edit screen 600, the CPU 200 allows the user to correct/modify the content. Since the edit screen 600 is larger than the small screens 532, 534, 536, it is easier to edit the content, thus the convenience of the operations of the image supply device 20 can be enhanced.

As described hereinabove, according to the second embodiment, since various functions such as the mirroring function, the multi-screen function, or the edit function are realized, the convenience of the image supply device can be enhanced. Further, since in the second embodiment the operable functions are visually indicated to allow the user to select these functions, it becomes possible to enhance the convenience of the image supply device 20.

### MODIFIED EXAMPLES

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present disclosure. Those with skill in the art will readily appreciate that embodiments in accordance with the present disclosure may be implemented in a very wide variety of ways.

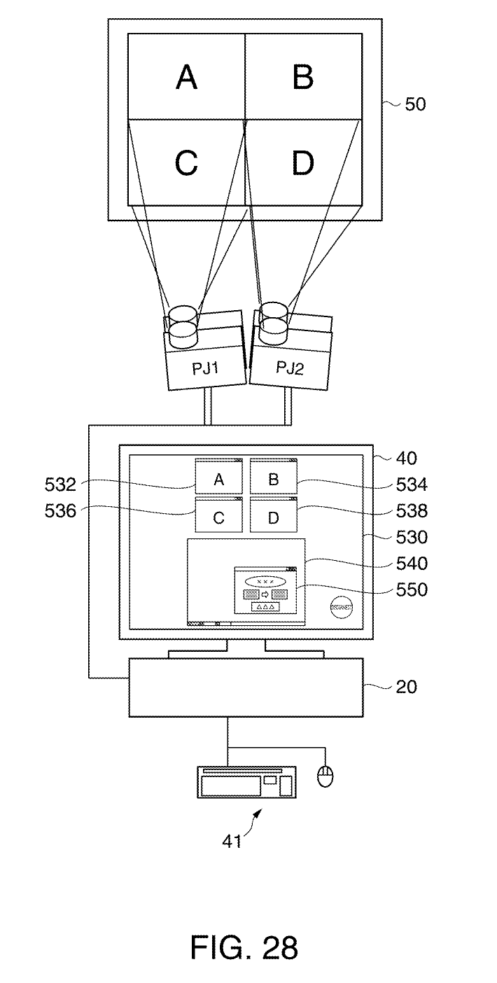

For example, FIG. 28 is an explanatory diagram showing a modified example. In the embodiments described above, since the projection screens of the image display devices 30 are arranged horizontally, the CPU 200 displays the small screens 532, 534, 536 arranged horizontally. However, depending on the arrangement of the projection screen, it is possible to modify the arrangement of the small screens 532, 534, 536. For example, in the case in which the projection images of the image display devices 30 are arranged in a 2×2 matrix, the CPU 200 can arrange the small screens 532, 534, 536, 538 in the 2×2 matrix. In general, in the case in which the projection images of the image display devices 30 are arranged in an n×m matrix, the CPU 200 can arrange the small screens in the n×m matrix.

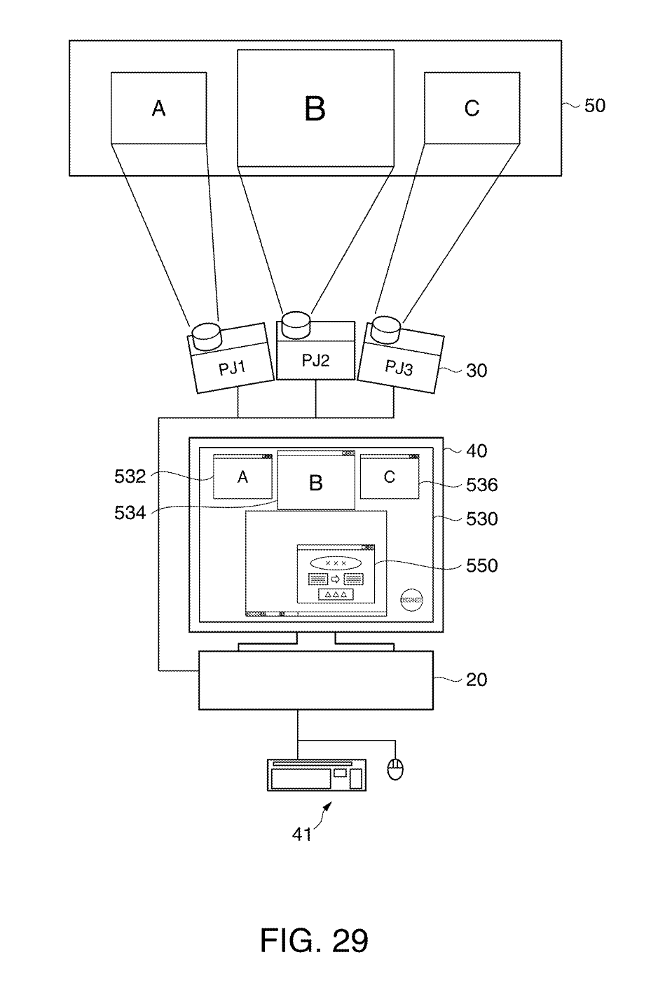

FIG. 29 is an explanatory diagram showing another modified example. In the case in which the sizes of the images displayed by the image display devices 30 are different from each other, the sizes of the small screens can be varied in accordance with the respective sizes. In the case in which the size of the image displayed by the image display device 30 (PJ2) is larger than the sizes of the images displayed by the image display devices 30 (PJ1, PJ3), the CPU 200 can display the small screen 534 with a larger size and the small screens 532, 536 with smaller sizes.

Although the disclosure is hereinabove explained based on some specific examples, the embodiments of the disclosure described above are only for making it easier to understand the disclosure, but not for limiting the scope of the disclosure. It should be readily appreciated that the disclosure may be modified or improved without departing from the scope of the disclosure and the present disclosure should be limited only be the appended claims and the equivalents thereof.

What is claimed is:

1. An image display control method configured to supply at least one image to N (N is an integer equal to or greater than 2) image display devices, the method comprising:
(a) forming N display areas corresponding to the N image display devices in a display section of an image supply device, the N display areas in the display section having a visually recognizable one-to-one correspondence with N display images displayed by the image display devices; and
(b) supplying the at least one image displayed in the respective display areas to the corresponding image display devices.

2. The image display control method according to claim 1, wherein the display areas have positions of arrangement and the method further comprises permitting movement of the positions of arrangement by a user.

3. The image display control method according to claim 1, wherein step (a) further comprises forming a miniature desktop area from a desktop screen and displaying the miniature desktop area in the display section.

4. The image display control method according to claim 3, wherein step (a) further comprises
forming one or more windows in the miniature desktop area, and
when a correspondence between one of the windows and one of the display areas is designated on the display section, displaying an image displayed in the one of the windows in the one of the display areas.

5. The image display control method according to claim 1, wherein step (a) further comprises, in response to a selection of one of the display areas, displaying a functional icon on the selected one of the display areas.

6. The image display control method according to claim 1, wherein step (a) further comprises
displaying a cursor for selecting the display area, and
in response to movement of the cursor onto one of the display areas, displaying a functional icon on the one of the display areas.

7. The image display control method according to claim 5, wherein a function associated with the functional icon includes at least one of
a mirroring function to display an image which is identical to the image displayed in the one of the display areas, in another of the display areas,
a multi-screen function to split the image displayed in the one of the display areas to form split screens and to display the split screens in the one of the display areas and in another of the display areas, respectively, and
an edit function to edit the image displayed on the one of the display areas.

8. The image display control method according to claim 7, wherein
upon execution of the edit function, an edit screen is displayed for editing the image displayed on the one of the display areas.

9. An image supply device configured to supply at least one image to N (N is an integer equal to or greater than 2) image display devices, comprising:
a display section;
an image display control section configured to form N display areas in the display section, and arrange the N display areas in the display section so that a one-to-one correspondence between N display images displayed by the image display devices and the N display areas is visually recognizable; and
an image supply section configured to supply the at least one image displayed in the display areas with the corresponding image display devices.

10. An image display control program product comprising instructions executable by a computer to control supply of at least one image to N (N is an integer equal to or greater than 2) image display devices, the instructions executable to perform functions comprising:
(a) forming N display areas corresponding to the N image display devices in a display section of an image supply device, the N display areas in the display section having a visually recognizable one-to-one correspondence with N display images displayed by the image display devices; and
(b) supplying the at least one image displayed in the respective display areas to the corresponding image display devices.
